(19) United States
(12) Patent Application Publication
(10) Pub. No.: US 2015/0294087 A1
(43) Pub. Date: Oct. 15, 2015

(54) ENGAGEMENT REPORTING TOOL FOR TRIAGE SUPPORT

(71) Applicant: BANK OF AMERICA CORPORATION, Charlotte, NC (US)

(72) Inventors: Marie Ashley S. Torres, Pasig City (PI); Jayvie A. Silvestre, Pasig City (PI)

(73) Assignee: BANK OF AMERICA CORPORATION, Charlotte, NC (US)

(21) Appl. No.: 14/252,014

(22) Filed: Apr. 14, 2014

(51) Int. Cl. G06F 19/00; G06Q 50/22

(52) U.S. Cl. CPC G06F 19/3487; G06Q 50/22

(57) ABSTRACT

Embodiments of the invention are directed to a system, method, or computer program product for a high priority incident engagement reporting tool for triage support. The tool reviews triage engagements, generates a report, and directs the report to the appropriate audience for triage. Furthermore, the invention may take incidents from across the entity and weigh the incidents for priority and impact. In this way, the invention receives, weighs, and triages any high priority incident that the entity may encounter. Thus the engagement reporting tool may allow for daily triage reporting in an efficient manner, thus streamlining formatting and sending of high priority incidents to the appropriate audiences.

### BACKGROUND

Typically, high priority incidents and tasks are delegated to a specific audience within a large entity for discussion and strategizing. These incidents are received from throughout the entity and triaged. Subsequently, the incidents are reported to the specific audience to discuss the challenges associated with the triaged incidents.

Support groups within the entity receive the high priority incidents. These groups review the incident, triage the incident, and a report is generated for the specific audience. Generally, the prioritization and reporting are manually created by an individual within the support group. As such, variations within the reporting and priority levels may be introduced prior to discussion and strategizing of the incident.

### BRIEF SUMMARY

The following presents a simplified summary of all embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of all embodiments in a simplified form as a prelude to the more detailed description that is presented later.

Embodiments of the present invention address the above needs and/or achieve other advantages by providing apparatus (e.g., a system, computer program product, and/or other devices) and methods for a high priority incident engagement reporting tool for triage support. In this way, the invention receives, weighs, and triages any high priority incident that the entity may encounter. Thus the engagement reporting tool may allow for daily triage reporting in an efficient manner, thus streamlining formatting and sending of high priority incidents to the appropriate audiences.

In some embodiments, the invention receives information about potential high priority incidents from one or more various groups from within the entity. In this way, the groups may report information associated with the incident directly for triage support. In other embodiments, the invention may reach out and pull information relating to potentially high priority incidents that may have been identified from one or more groups within the entity.

In some embodiments, the engagement reporting tool may be accessed and opened at a local user device. In this way, the user may be able to access and use the engagement reporting tool at any location within the entity or remotely. The user may be able to utilize an engagement report generator to generate a report for one or more different date ranges, times, groups, or the like. The engagement report generator may be presented to the user upon accessing the engagement tool.

Prior to accessing the engagement tool, the system may identify and extract high priority incidents for triage support from the received potential high priority incidents. As such, the invention may identify the high priority incidents across the entity from a pool of incidents received or pulled from one or more groups within the entity. High priority incidents may be one or more incidents that a group within the entity may have that may affect other groups within the entity.

In some embodiments, once the high priority incidents for triage support are extracted from the received information about potential high priority incidents, the invention proceed to retrieve and/or create engagement information from each of the extracted high priority incidents. In this way, triage support may be engaged for each of the high priority incidents, thus creating a ticket number and the like for each of the one or more engagements. Furthermore, other engagement information such as an application code, application, the priority ranking, impact ranking, information about group communications, and external impacts of the incident may be generated.

Subsequently, the audience to present each of the one or more extracted high priority incidents is identified. The presentation may be in the form of an interface, illustrating an engagement report. The audience may be one or more triage support associates, individuals associated with the group originating the incident, managers, experts, or the like.

In some embodiments, once the audience has been identified a template for reporting the incidents to all of the members of the audience is generated and formatted. As such, an email, mail, voice communication, or the like may be generated for the one or more individuals of the audience.

In some embodiments, the formatted template is then sent to each of the audience member. Subsequently, the engagement reporting tool may present a report to each of the members of the audience and a meeting or discussion may be facilitated to discuss and resolve the high priority incidents for the institution.

Embodiments of the invention relate to systems, methods, and computer program products for triage engagement reporting, the invention comprising: generating and presenting engagement reporting tool to a user such that the engagement reporting tool is stored locally with the user; retrieving information about one or more incidents within an entity, wherein the retrieved information about the one or more incidents is based at least in part on the user selecting a range of information to retrieve; ranking priority and impact of the one or more incidents, wherein high priority incidents are identified; populating a triage engagement report with triage information for each of the high priority incidents identified; determining triage support audience associated with the triage engagement report; and presenting the triage engagement report to the triage support audience.

In some embodiments, the invention further comprises extracting high priority incidents for triage support from the retrieved information about one or more incidents.

In some embodiments, high priority incidents are incidents within a group at the entity that are associated with financial aspects of the group including payments.

In some embodiments, ranking the priority and the impact of the one or more incidents includes applying logic to each of the incidents to determine the highest priority, wherein the logic includes learning from historical incident rankings, comparing a type of incident across the one or more incidents, and comparing groups where the one or more incidents originated.

In some embodiments, retrieving information about one or more incidents within an entity further comprises the user selecting a date range, priority of incident, type of incident, or field of incident for the retrieving.

In some embodiments, triage information populated on the triage engagement report includes generating a ticket number, generating an application code, generating a weight and impact, presenting communication summaries, and notes for each of the high priority incidents identified. In some embodiments, triage information populated on the triage engagement report include a generating a ticket number linked to the data about the high priority incident not on the engagement report.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a high level process flow illustrating the process of utilizing the engagement reporting tool for triage support, in accordance with embodiments of the invention;

FIG. 2 provides an illustration of a engagement reporting tool for triage support system environment, in accordance with various embodiments of the invention;

FIG. 3a provides a process flow illustrating engagement reporting tool updating and report generation, in accordance with embodiments of the invention;

FIG. 3b provides a process flow illustrating engagement reporting tool updating and report generation, in accordance with embodiments of the invention;

FIG. 4 illustrates a detailed process for a user utilization of the engagement reporting tool for triage support, in accordance with embodiments of the invention;

FIG. 5 provides an illustration of an engagement reporting tool for triage support, in accordance with embodiments of the invention; and

FIG. 6 provides an illustration of an engagement reporting correspondence for communicating an engagement reporting tool for triage support, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Furthermore, embodiments of the present invention use the term “user.” It will be appreciated by someone with ordinary skill in the art that the user may be an individual, financial institution, corporation, or other entity that may have documents associated with accounts, transactions, or the like with the entity providing the system. The term “group” as presented herein may refer to one or more lines of business, groups, subsidiaries, business partners, or the like that are associated with an entity that has triage reporting and support.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of entities that have electronic document or data storage needs.

Typically, large entities may triage support units or groups that may aid in triaging and solving incidents of priority that may arise within the entity. These incidents may include one or more transactions, correspondences, or the like that may be abnormal or require manager authorization. In some embodiments, the incidents may be determined by the entity. In other embodiments, the incidents may include one more incidents associated with financial aspects of the entity.

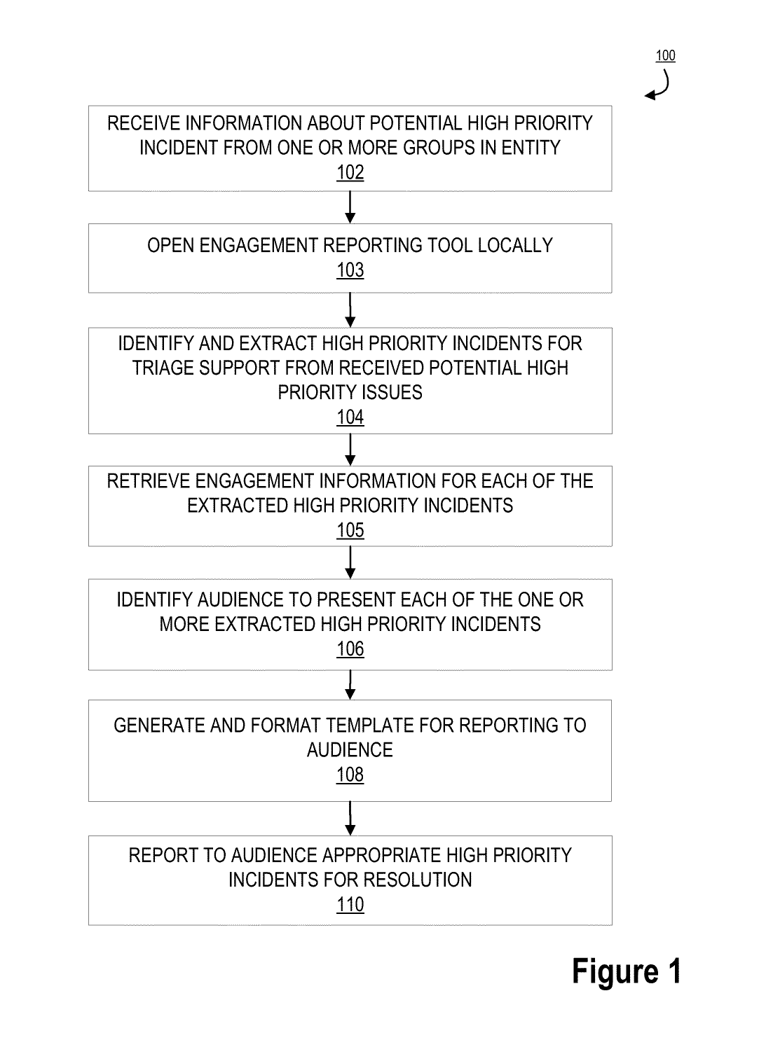

FIG. 1 provides a high level process flow illustrating the process of utilizing the engagement reporting tool for triage support 100, in accordance with embodiments of the invention. As illustrated in block 102, the process 100 is initiated when the system receives information about potential high priority incidents from one or more various groups from within the entity. In some embodiments, the groups may report information associated with the incident directly for triage support. In other embodiments, the system may reach out and pull information relating to potentially high priority incidents that may have been identified from one or more groups within the entity. High priority incidents may be one or more incidents that a group within the entity may have that may affect other groups within the entity. Incidents may include any transaction, correspondence, or the like that may be abnormal or require manager authorization. In some embodiments, high priority incidents may be determined by the entity. These high priority incidents may include one more incidents associated with financial aspects of the entity. In some embodiments, the high priority or potential high priority incidents may require triage support from a triage support group within the entity and/or support from a collaboration of individuals to solve the high priority incident.

Next, as illustrated in block 103, the process continues by opening the engagement reporting tool at a local user device. In this way, the user may be able to access and use the engagement reporting tool at any location within the entity or remotely. The user may be able to utilize an engagement report generator to generate a report for one or more different date ranges, times, groups, or the like. Then, as illustrated in block 104 the engagement reporting tool may identify and extract high priority incidents for triage support from the received potential high priority incidents. In this way, the system may identify the high priority incidents across the entity from a pool of incidents received or pulled from one or more groups within the entity. As such, while an incident may be higher priority for the group, the entity overall may identify that incident as being lower priority with respect to others received. In this way, the system identifies and extracts information from only the high priority incidents for triage support.

Once the high priority incidents for triage support are extracted from the received information about potential high priority incidents, the process 100 continues by retrieving and/or creating engagement information from each of the extracted high priority incidents, as illustrated in block 105. In this way, the system may engage triage support for each of the high priority incidents, thus creating a ticket number and the like for each of the one or more engagements. Furthermore, other engagement information such as an application code, application, the priority ranking, impact ranking, information about group communications, and external impacts of the incident.

Next, as illustrated in block 106, the system may identify the audience to present each of the one or more extracted high priority incidents to in the form of an engagement report. The audience may be one or more triage support associates, individuals associated with the group originating the incident, managers, experts, or the like.

Once the audience has been identified, the process 100 continues by generating and formatting a template for reporting the high priority incidents to all of the members of the audience. As such, an email, mail, voice communication, or the like may be generated for the one or more individuals of the audience. Finally, as illustrated in block 110, the process 100 ends by reporting to the audience the appropriate high priority incidents for discussion and resolution.

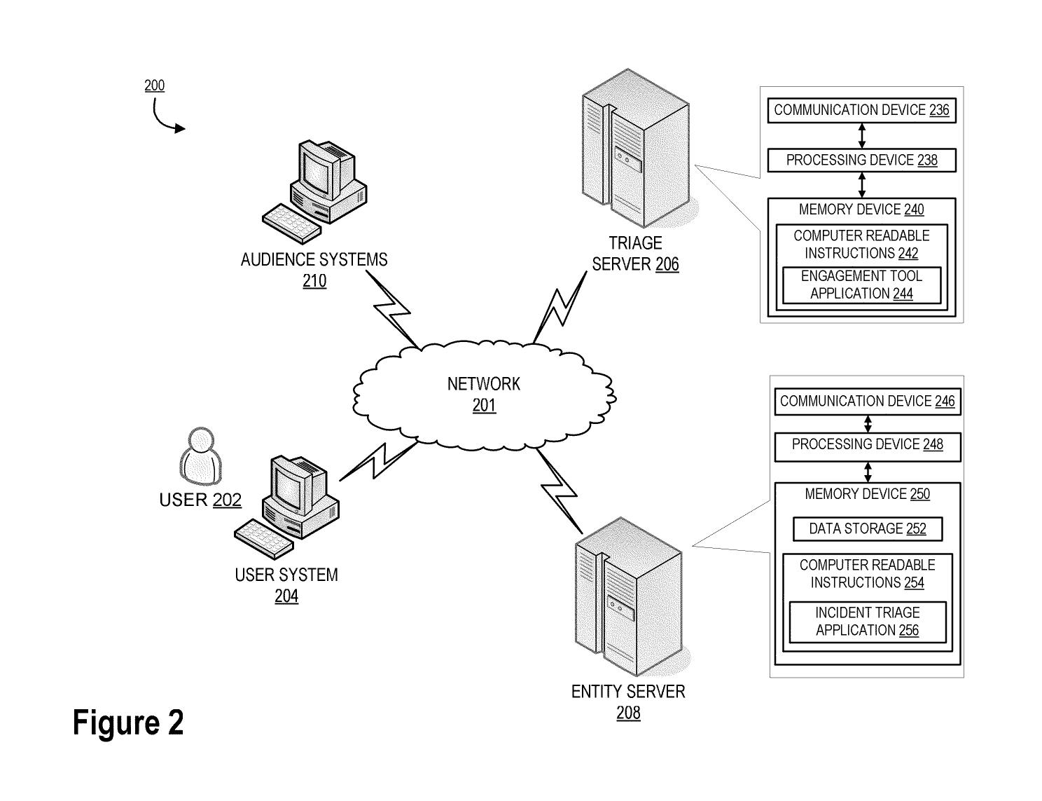

FIG. 2 illustrates an engagement reporting tool for triage support system environment 200, in accordance with various embodiments of the invention. As illustrated in FIG. 2, the entity server 208 is operatively coupled, via a network 201 to the user system 204, the triage server 206, and the group systems 210. In this way, the entity server 208 can send information to and receive information from the user system 204, triage server 206, and the audience systems 210 to provide for user document indexing and presentment.

FIG. 2 illustrates only one example of an engagement reporting tool for triage support system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual that an affiliation with the entity triage support group. In this way, the user 202 may be an employee, manager, associate, customer, vendor, or another individual associated with triage support for the entity. In some embodiments, the user 202 may be a group manager or business manager for the entity. Furthermore, multiple individuals or entities may comprise a user 202, such as a group within the entity or multiple associates.

As illustrated in FIG. 2, the entity server 208 may include a communication device 246, processing device 248, and a memory device 250. The processing device 248 is operatively coupled to the communication device 246 and the memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device. The processing device 248 uses the communication device 246 to communicate with the network 201 and other devices on the network 201, such as, but not limited to the user system 204, audience systems 210, and/or triage server 206 over a network 201. As such, the communication device 246 generally comprises a modem, server, or other device for communicating with other devices on the network 201.

As further illustrated in FIG. 2, the entity server 208 comprises computer-readable instructions 254 stored in the memory device 250, which in one embodiment includes the computer-readable instructions 254 of an incident triage application 256. In some embodiments, the memory device 250 includes data storage 252 for storing data related to the incident triage application 256 including but not limited to data created and/or used by the incident triage application 256.

In the embodiments illustrated in FIG. 2 and described throughout much of this specification, the incident triage application 256 receives potential high priority incidents, retrieves potential high priority incidents, compiles the high priority incidents, run logic to identify priority and impact of the incidents, extracts appropriate data for report, and send data to triage server for report.

In some embodiments, the incident triage application 256 may receive potential high priority incidents from within the entity. In some embodiments, the incident triage application 256 may receive the data from throughout the entity. They may be received via the network 201 or via other communications. The potential high priority incidents may be incidents within a group at the entity that may require additional triage support, such as those incidents dealing with financial issues.

In some embodiments, the incident triage application 256 may retrieve information about potential high priority incidents. In this way, the incident triage application 256 may search the entity for information that may lead to a high priority incident. In this way, the incident triage application 256 may track and incorporate retrieved information until the engagement reporting tool.

In some embodiments, the incident triage application 256 may compile the high priority incidents for a date range selected by a user 202. In this way, the user 202 may select specific dates, incidents, or the like that he/she wishes to review and receive engagement tracker data on. The incident triage application 256 may extract the data and subsequently run logic on the data to identify priority and impact of the incidents.

The incident triage application 256 may then receive an indication to generate a report for presenting the high priority incidents to the user 202 and an audience. The report may include some of the data received and/or retrieved by the incident triage application 256 for high priority incidents. In this way, the incident triage application 256 may extract appropriate data for report from the received and/or retrieved data. The incident triage application 256 may then provide the data to the triage serve 206 to populate a report via the engagement reporting tool for triage support.

As illustrated in FIG. 2, the triage server 206 generally comprises a communication device 236, a processing device 238, and a memory device 240. The processing device 238 is operatively coupled to the communication device 236 and the memory device 240. The processing device 238 uses the communication device 236 to communicate with the network 201 and other devices on the network 201, such as, but not limited to the entity server 208, the audience systems 210, and the user system 204. As such, the communication device 236 generally comprises a modem, server, or other device for communicating with other devices on the network 201.

As further illustrated in FIG. 2, the triage server 206 comprises computer-readable instructions 242 stored in the memory device 240, which in one embodiment includes the computer-readable instructions 242 of an engagement application 244. In some embodiments, the memory device 240 includes database storage for storing data related to the engagement application 244 including but not limited to data created and/or used by the engagement application 244.

In the embodiments illustrated in FIG. 2 and described throughout much of this specification, the engagement application 244 may insert the engagement reporting tool locally, receive requests for engagement report via engagement tracker, report requests to entity server, receive data from the entity server, populate engagement report, format the communication to the audience, and send engagement report to audience.

The engagement application 244 may first build the engagement reporting tool. Once built, the engagement application 244 may insert the engagement reporting tool onto one or more user systems 204, such that the user 202 may have access to the engagement reporting tool locally.

The engagement application 244 may receive requests for engagement report via engagement report generator as part of the engagement tracker. In this way, a user 202 may access the engagement reporting tool locally. At this point, the engagement application 244 may present the user 202 with the engagement report generator. The engagement application 244 may receive an indication that the user 202 wishes to run a report for a specific time period. Subsequently, the engagement application 244 sends a request to the entity server 208 for the specific data for the time period requested by the user 202 for each of the one or more high priority incidence that occurred during that period. The engagement application 244 may communication with the entity server 208 to extract data associated with each of the high priority incidence.

Once the engagement application 244 requests the data, the entity server 208 may send the data to the engagement application 244 via the network 201. When the engagement application 244 receives the data, the engagement application 244 may populate the engagement report with some of the data received. In this way, the engagement application 244 may determine the critical data and present that data in the engagement report. As such, in some embodiments, the engagement application 244 may not report all of the date received for each of the high priority incidents. In this way, the engagement application 244 may identify the necessary information for each report and populate the report with that information. The necessary information may be learned from historic reports, received from user 202 input, or the like.

Next, once the information is received and the report is populated, the engagement application 244 may format the communication for the specific audience. In some embodiments, the engagement application 244 may determine the audience based on the data associated with the report. In other embodiments, the user 202 may present the engagement application 244 with addresses for each of the members of the audience. The engagement application 244 may format the communications to be compatible with the communication type selected for distribution of the engagement report. In some embodiments, the communication type may be electronic, text, voice, or the like communications. In preferred embodiments, the communication type may be an email. Finally, the engagement application 244 may send the engagement report to audience via the communication channel desired.

FIG. 2 also illustrates a user system 204. The user system 204 is operatively coupled to the entity server 208, audience systems 210, and/or the triage server 206 through the network 201. The user system 204 has systems with devices the same or similar to the devices described for the entity server 208 and/or the triage server 206 (e.g., communication device, processing device, and memory device). Therefore, the user system 204 may communicate with the entity server 208, audience systems 210, and/or the triage server 206 in the same or similar way as previously described with respect to each system. The user system 204, in some embodiments, is comprised of systems and devices that allow for a user 202 to access the engagement reporting tool for triage support locally. As such, the user 202 may be able to access the tool and the engagement report generator to review high priority incidents and provide the necessary documentation to the audience effectively over the network 201.

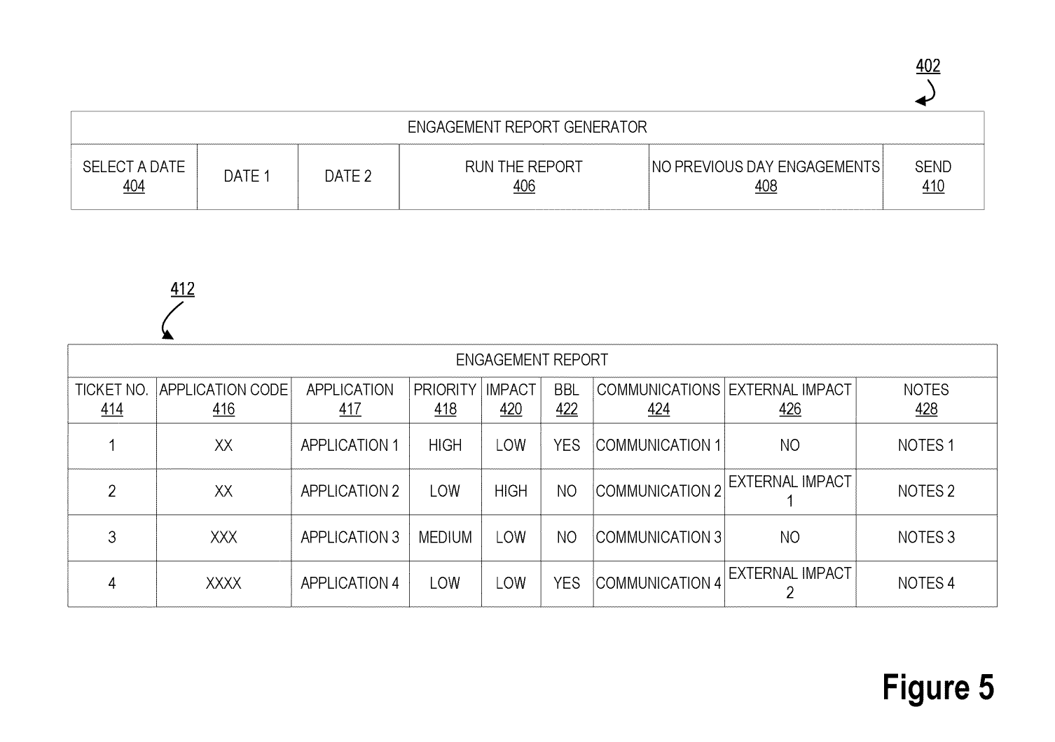

As such the user system 204 may be identified by the triage server 206 and/or the entity server 208 and may present the user 202 via the user system 204 access to the engagement reporting tool. In this way, the users 202 may have access to the tool and information for reports of high priority incidents associated with the same such as ticket numbers, application code, application, priority, impact business bridge line information, communications, external impacts, notes, or the like which are further illustrated below with respect to FIG. 5.

A “user device” 204 may be any mobile or computer communication device, such as a cellular telecommunications device (e.g., a cell phone or mobile phone), personal digital assistant (PDA), a mobile Internet accessing device, or other mobile device including, but not limited to portable digital assistants (PDAs), pagers, mobile televisions, gaming devices, laptop computers, desktop computers, cameras, video recorders, audio/video player, radio, GPS devices, any combination of the aforementioned, or the like. Although only a single user system 204 is depicted in FIG. 2, the system environment 200 may contain numerous user systems 204, as appreciated by one of ordinary skill in the art.

FIG. 2 also illustrates audience systems 210. The audience systems 210 are operatively coupled to the entity server 208, user system 204, and/or the triage server 206 through the network 201. The audience systems 210 has systems with devices the same or similar to the devices described for the entity server 208 and/or the triage server 206 (e.g., communication device, processing device, and memory device). Therefore, the audience systems 210 may communicate with the entity server 208, user system 204, and/or the triage server 206 in the same or similar way as previously described with respect to each system. The audience systems 210, in some embodiments, are comprised of systems and devices that allow for receiving reports of appropriate high priority incidents within the entity for resolution. In some embodiments, the audience systems 210 may also generate documents and other data for discussions related to the high priority incidents. In yet other embodiments, the audience systems 210 may generative the original potential high priority incident for triage review. Furthermore, audience systems 210 may receive populated templates based on the information associated with the one or more high priority incidents of an engagement report. In some embodiments, audience systems 210 and user systems 204 may be interchangeable within the system environment 200. In this way, the audience systems 210 may be associated with groups such as lines of business, groups, subsidiaries, business partners, or the like associated with the entity.

FIG. 2 depicts only one audience systems 210 within the system environment 200, however, one of ordinary skill in the art will appreciate that a plurality of audience systems 210 may be communicably linked with the network 201 and the other devices on connected to the network 201, such that each audience systems 210 is communicably linked to the network 201 and the other devices on the network 201.

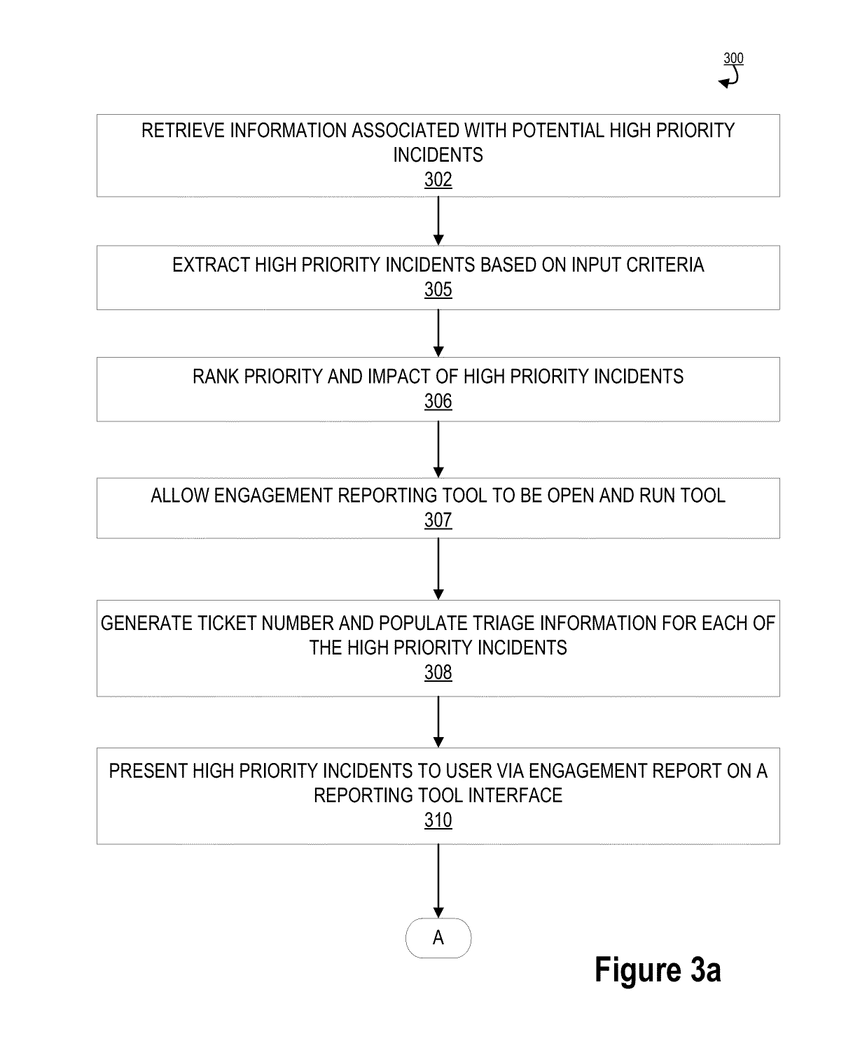

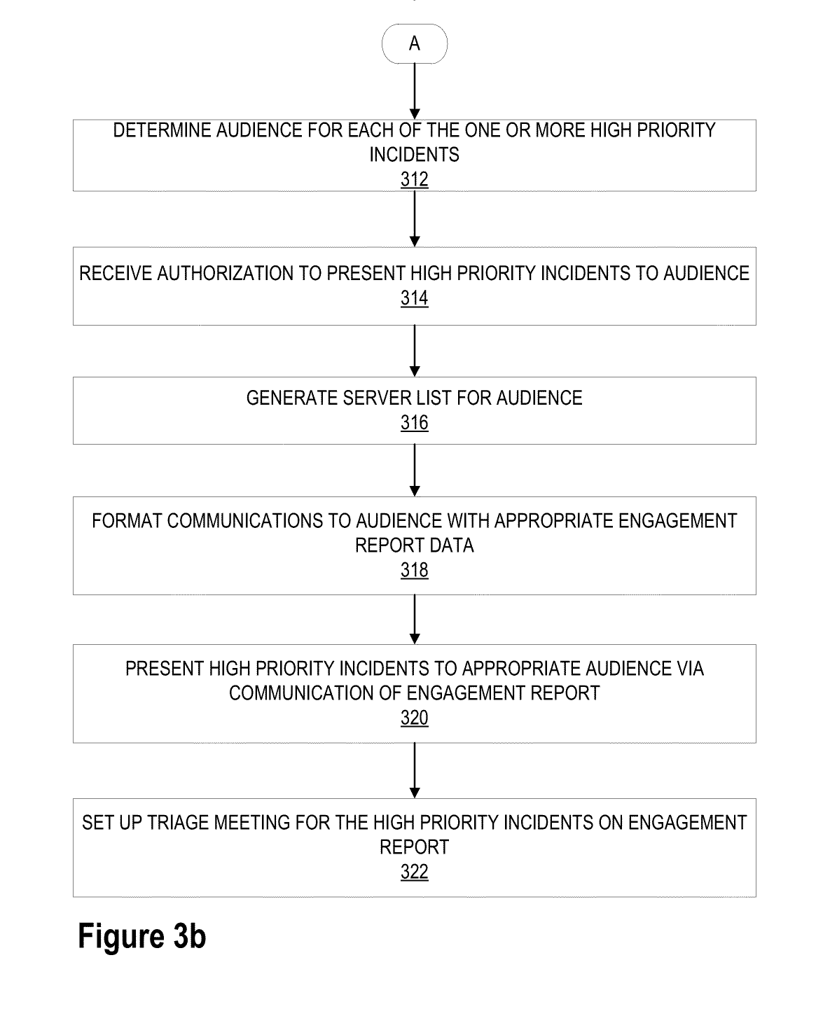

FIG. 3a illustrates a process flow for engagement reporting tool updating and report generation 300, in accordance with embodiments of the invention. The process 300 is initiated by receiving information associated with potential high priority incidents within an entity, as illustrated in block 302. The data may be inputted to a centralized server or data sharing platform for use across the entity. The data may be inputted by one or more groups where the incident has developed. In some embodiments, the groups may report information associated with the incident directly to the system for triage support. In yet other embodiments, the system may reach out and pull information relating to potentially high priority incidents that the system may have been identified from one or more groups within the entity.

Next, as illustrated in block 305, the system may extract high priority incidents based on the inputted criteria. In this way, the system may extract data for the time period, group, or the like selected by the user 202. The system then extracts all potentially high priority incidents stored within that time period. This data may be sent to the system and/or pulled by the system.

Next, as illustrated in block 306, the system may rank the priority and impact of the high priority incidents. Ranking of the priority and impact are both done using logic, algorithms, artificial learning and selection, and/or are manually selected by a triage support associate. The priority of the incident includes the importance of the incident with respect to the entire entity. The impact of the incident includes the most negative or positive impact of the incident with respect to the entire entity. Logic is applied using historic data of triage support. As such, the system may, using logic, a weight to apply to determine the priority of each of the incidents. The logic applied may be an algorithm, learned artificial intelligence based on prior weeks/months/years of reporting, manager input, or the like and/or a combination thereof. In this way, the system learns from historic data which type of incidents are the highest priority associated with the entity. The rankings may be learned over time based on an application of logic to similar high priority incidents that are identified in the current report compared to historic reports generated in the past. In some embodiments, the system may receive a priority and/or impact from a user 202, manager, group, or the like to apply to the high priority incident for triage support. In some embodiments, these incidents include the financial or transactional incidents associated with customers, vendors, or the like.

Once logic is applied to each of the incidents within the date range, the system, via the engagement tracker, may rank the incidents in order of either priority, impact, or the like as illustrated in block 306. In this way, the system may rank the incidents based on various different criteria. In some embodiments, the incidents may be ranked based on priority, from high to low or low to high. In some embodiments, the incidents may be ranked based on impact. In other embodiments, the incidents may be ranked based on date. In still other embodiments, the incidents may be ranked based on audience to receive the incident for triage support.

Next, as illustrated in block 307 the process 300 continues when a user 202 may open the engagement reporting tool and select the time frame to generate a report. In this way, the system may open the engagement reporting tool and run the same. The user 202 may select from the one or more dates, groups, specific high priority incidents, or the like. The user 202 may select generation of the report via an interface generated by the tool. In some embodiments, the interface may be the engagement report generator, as further illustrated in FIG. 5.

Once the user 202 opens the engagement reporting tool, the system may generate a triage support ticket number for each of the one or more high priority incidents, as illustrated in block 308. As further illustrated in block 308, triage information may be populated for each of the high priority incidents. This data may include an application code, application, priority, impact, business bridge line, communications, external impacts, notes, and/or the like. In some embodiments, the populated triage information for each incident may include creating a visual basic for applications macro based spreadsheet file that may connect to the engagement tracker tool from a server to automate the production of the engagement report.

Next, as illustrated in block 310, the engagement tool may present the high priority incidents to the user via an engagement report on a reporting tool interface. In this way, the tool utilizes the engagement tracker to retrieve all high priority incidents, rank the incidents, and generate and compile the incidents and data associated with the same into an engagement report for the user 202 to preview. As such, the user 202 may review the report, the data associated with each high priority incident, and edit or amend any of the report that is necessary. The process 300 continues at FIG. 3b.

As illustrated in FIG. 3b, the process flow for engagement reporting tool updating and report generation 300, in accordance with embodiments of the invention, continues. As illustrated in block 312 of FIG. 3b, the process 300 continues from block 310 of FIG. 3a, to determine an audience for each of the one or more high priority incidents. The audience is determined by the user 202 and/or the system via the engagement reporting tracker. In this way, the system may identify the type of incident and group the incident is associated with. Then the system may identify one or more triage support associates with experience for that particular type of incident. Furthermore, the system may identify the group leader, manager, or the like associated with the incident and determine if he/she may need to be involved in the triage. The determination of the audience is based on need, experience, or the like in order to most efficiently discuss and mitigate the exposure associated with the incident.

Next, as illustrated in block 314 of FIG. 3b the process 300 continues by receiving authorization from a user 202 to present the high priority incidents to the audience, via the engagement report. Authorization may be given after the user 202 or other triage associate reviewed the initially generated report. In some embodiments, authorization is given prior to the generation of the report, such that the system may continue to present the communications to the audience once generated.

As illustrated in block 316, once authorization is give, if necessary, then the system may generate a server list for the audience. The server list may be one or more email addresses, voice communication links, text communications, or the like lists of the audience for each of the one or more high priority incidents.

Once the server list is generated, the process may continue to format communications to audience with the appropriate engagement tracking and reporting data, as illustrated in block 318. As such, the system may take the information about each of the one or more high priority incident and format the data for presentation to the appropriate audience. In some embodiments, the data may be formatted into a spreadsheet, text document, or the like. The data may be formatted to conveniently view the high priority incidents for resolution. Furthermore, the system may generate a master data spreadsheet illustrating all received data associated with each of the one or more high priority incidents. In some embodiments, the system may take specific information from master to populate the communications. In this way, the system may show or hide specific data from the engagement report. Once the data has been selected, the engagement report may be formatted to the correct format for access and viewing by each of the one or more individuals of the audience.

Next, as illustrated in block 320, the process 300 continues to present the high priority incidents to the appropriate audience via communication of the engagement report. In this way, the system may populate an email, text, or the like communication. The communication may be addressed to the audience. The system may populate the communication with the appropriate engagement report and subsequently send the engagement report. Finally, as illustrated in block 322, the process 300 is completed when a triage meeting is set up and conducted for the high priority incidents on the engagement report.

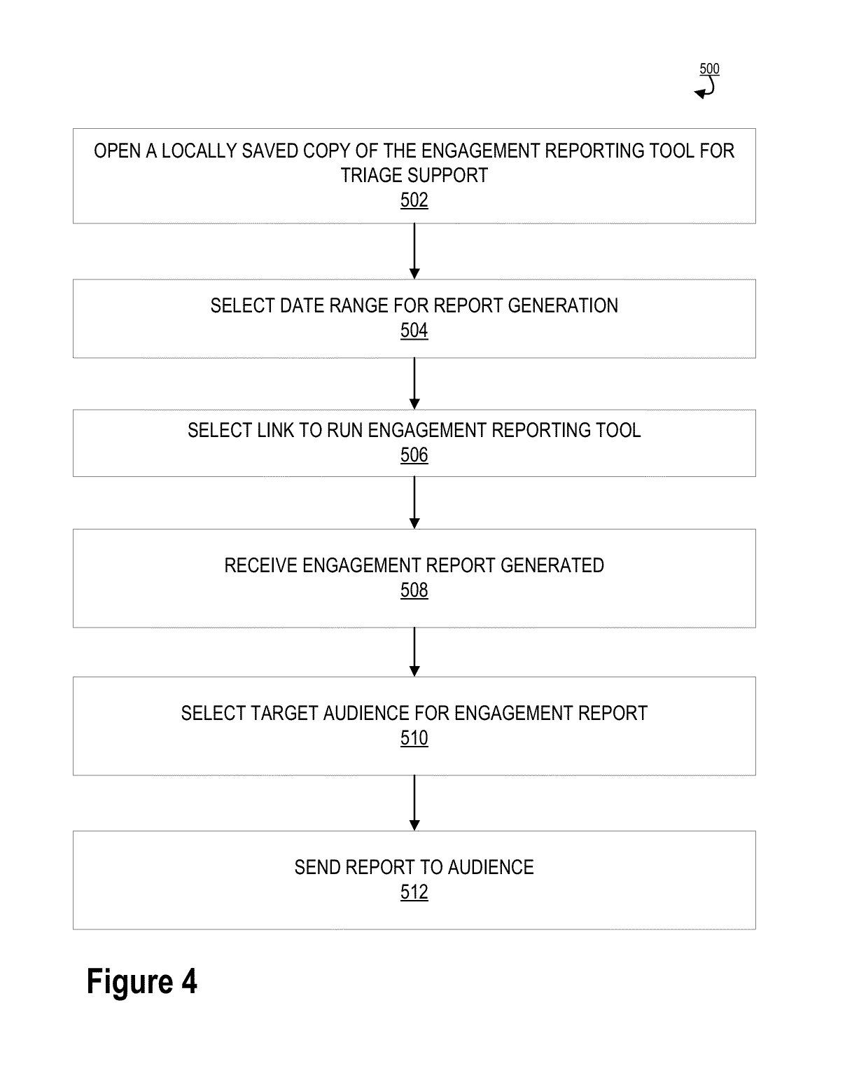

FIG. 4 illustrates a detailed process for a user utilization of the engagement reporting tool for triage support 500, in accordance with embodiments of the invention. As illustrated in block 502, the process 500 is initiated when a user 202 opens a locally saved copy of the engagement reporting tool for triage support. The user 202 may access the tool via an application, link, icon, local storage drive, or the like from the user device. Once opening a locally saved copy of the engagement reporting tool for triage support, the user 202 is presented with an engagement report generator, which is illustrated in more detail below with respect to FIG. 5.

Next, as illustrated in block 504, the user 202 may next select the date range for the report. In this way, the user 202 will be able to select to view all active, pending, new, and/or completed triage supports in progress for each of the one or more high priority incidents for a range of dates or a single day. Once the date is selected by the user 202, he/she may select the link to run the engagement reporting tool, as illustrated in block 506.

FIG. 5 illustrates an engagement reporting tool for triage support, in accordance with embodiments of the invention. Section 402 illustrates an engagement report generator. The engagement report generator is accessed when a user 202 accesses the engagement reporting tool locally. The engagement report generator allows the user 202 to select a date range in section 404. In this way, the user 202 may select a date or range of dates for the report. In this way, the user 202 may view triage incidents and statuses associated with the same that are in process, new, or already settled. In the engagement report generator 402 illustrated in FIG. 5, the user 202 selected a date range between date 1 and date 2. In this way, the user 202 will view all active, pending, new, and completed triage in progress for each of the one or more high priority incidents. Once the user 202 has selected the date in section 404, he/she can run the report, as illustrated in section 406. The engagement report generator 402 may also provide an instant indication to the user 202 if the triage support team has been engaged that day, as illustrated in block 408. In this way, the system may present the user 202 with an easy view of whether triage support has been needed that day for any group within the entity.

Referring back to FIG. 4, the process 500 continues at block 508, the user 202 may receive the engagement report that was generated by the system. An example engagement report is illustrated in FIG. 5.

FIG. 5 illustrates an engagement reporting tool for triage support, in accordance with embodiments of the invention. As illustrated in section 412 an engagement report is presented as part of the engagement reporting tool for triage support to the user 202 via an interface. As illustrated in section 414 the engagement report includes a generated ticket number for the high priority incident for triage support. In the example illustrated in FIG. 5, there are 4 ticket numbers corresponding to 4 high priority incidents for triage support that were identified in the date range selected by the user 202 for the engagement reporting too for triage support. The ticket numbers are linked directly to one or more databases which include more details about each of the high priority items associated with their respective ticket number. Next, the engagement report 412 includes an application code for each of the high priority incidents to be triaged, as illustrated in section 416. The application code may include information about the type of incident, the group associated with the incident, or the like. Next, as illustrated in section 417, the engagement report generated from the engagement tool may also include a description of the application.

Next, the engagement report 412 includes a priority 418 of each of the high priority incidents. In this way, the system may apply logic to each of the high priority incidents compiled within the date range and rank them in an order of priority. In some embodiments, this includes high, low, and medium priority levels.

Next, the engagement report 412 includes an impact 420 of each of the high priority incidents. In this way, the system may apply logic to each of the high priority incidents compiled within the date range and rank them in an order of impact. In some embodiments, this includes high, low, and medium priority levels of impact. The impact could include impact to the individual, group, entity, or external impact.

Ranking of the priority and impact are both done using logic, algorithms, artificial learning and selection, and/or are manually selected by a user 202. The priority of the incident includes the importance of the incident with respect to the entire entity. The impact of the incident includes the most negative or positive impact of the incident with respect to the entire entity. Logic is applied using historic data of triage support. As such, the system may, using logic, a weight to apply to determine the priority of each of the incidents. The logic applied may be an algorithm, learned artificial intelligence based on prior weeks/months/years of reporting, manager input, or the like and/or a combination thereof. In this way, the system learns from historic data which type of incidents are the highest priority associated with the entity. The rankings may be learned over time based on an application of logic to similar high priority incidents that are identified in the current report compared to historic reports generated in the past. In some embodiments, the system may receive a priority and/or impact from a user 202, manager, group, or the like to apply to the high priority incident for triage support. In some embodiments, these incidents include the financial or transactional incidents associated with customers, vendors, or the like.

As illustrated in section 422, the engagement report 412 also includes a column indicating if a business bridge line exists. The business bridge line may be in place if the line of business associated with the incident needs to be engaged to discuss the impact of a technical incident or the like. Next, as illustrated in section 424, the engagement report 412 includes a brief statement of any communications, either internal or external, about the incident. As such, the audience that may receive the report may have information about each of the one or more incidents, such that they may be up-to-date on each of the incidents for discussion.

Next, as illustrated in section 426 the engagement report 412 includes an external impact column. In this way, the system may provide the user 202 and/or audience with information about the external impact of each of the incidents. As illustrated in the example of FIG. 5 the incident associated with ticket number 1 has no external impact, the incident associated with ticket number two has External Impact 1, the incident associated with ticket number 3 has no external impact, and the incident associated with ticket number 4 has External Impact 2.

Finally, as illustrated in section 428, the engagement report 412 also includes notes for the triage support team and audience for the resolution of the high priority incident.

Importantly, the information presented in the engagement reporting tool may be all or some of the data received by the system for each of the one or more high priority incidents for triage. In this way, the system may select the data for each of the engagement reports generated. Thus, the system may present some or all of the information about each of the high priority incidents. In this way, the system may tailor the engagement report for the audience that will view the information.

Referring back to FIG. 4, the process 500 continues at block 510, where the user 202 may select the target audience to receive the generated engagement report. In some embodiments the user 202 may decide and preparing the communications to be directed to the appropriate audience. In some embodiments, the system may determine the address correspondences for each of the members of the audience. Finally, once the target audience is selected and communication addresses are inputted, the user 202 may send the report to the target audience, as illustrated in block 512.

Referring again back to FIG. 5, the engagement report generate 402 that has been presented to the user 202, may allow the user 202 to send the report to the target audience, as illustrated in section 410.

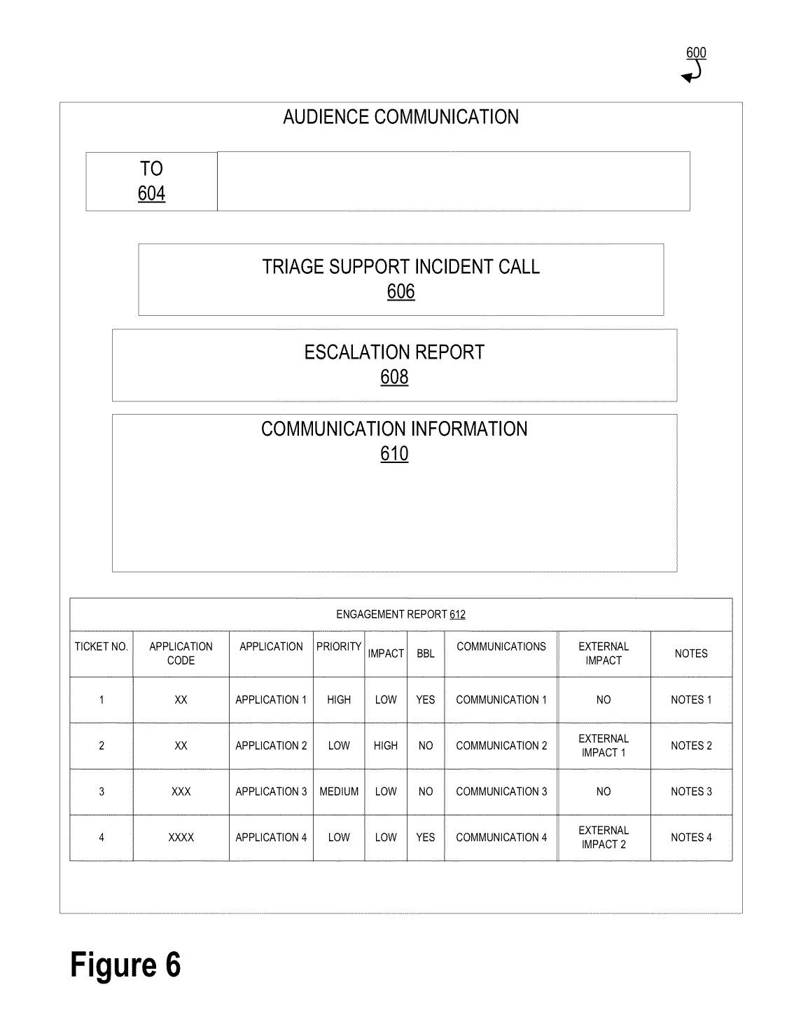

FIG. 6 illustrates an engagement reporting correspondence for communicating an engagement reporting tool for triage support 600, in accordance with embodiments of the invention. As illustrated in FIG. 6, an audience communication example is presented. As illustrated in section 604, the audience communication may be addressed to one or more individual audience members. Next, as illustrated in section 606 the audience communication may include a subject and time of a triage support conference to discuss the high priority incidence of the report. Next, the communication may have information about an escalation report 608, such as a date or time of the report or meeting. In some embodiments, the audience communication may also include communications information 610. Communications information 610 may include any information associated with the triage support, such as meeting times, call in telephone number, further information about each of the incidences, or the like. Finally, the engagement report 612 is attached to the audience communication.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, or the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational phases to be performed on the computer or other programmable apparatus to produce a computer-implemented process such that the code portions which execute on the computer or other programmable apparatus provide phases for implementing the functions/acts specified in the flowchart and/or block diagram block(s). Alternatively, computer program implemented phases or acts may be combined with operator or human implemented phases or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that phases of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for triage engagement reporting, the system comprising:
a memory device with computer-readable program code stored thereon;
a communication device;
a processing device operatively coupled to the memory device and the communication device, wherein the processing device is configured to execute the computer-readable program code to:
generate and present engagement reporting tool to a user such that the engagement reporting tool is stored locally with the user;
retrieve information about one or more incidents within an entity, wherein the retrieved information about the one or more incidents is based at least in part on the user selecting a range of information to retrieve;
rank priority and impact of the one or more incidents, wherein high priority incidents are identified;
populate a triage engagement report with triage information for each of the high priority incidents identified;
determine triage support audience associated with the triage engagement report; and
present the triage engagement report to the triage support audience.

2. The system of claim 1 further comprising extracting high priority incidents for triage support from the retrieved information about one or more incidents.

3. The system of claim 1, wherein high priority incidents are incidents within a group at the entity that are associated with financial aspects of the group including payments.

4. The system of claim 1, wherein ranking the priority and the impact of the one or more incidents includes applying logic to each of the incidents to determine the highest priority, wherein the logic includes learning from historical incident rankings, comparing a type of incident across the one or more incidents, and comparing groups where the one or more incidents originated.

5. The system of claim 1, wherein retrieving information about one or more incidents within an entity further comprises the user selecting a date range, priority of incident, type of incident, or field of incident for the retrieving.

6. The system of claim 1, wherein triage information populated on the triage engagement report includes generating a ticket number, generating an application code, generating a weight and impact, presenting communication summaries, and notes for each of the high priority incidents identified.

7. The system of claim 1, wherein triage information populated on the triage engagement report include a generating a ticket number linked to the data about the high priority incident not on the engagement report.

8. A computer program product for triage engagement reporting, the computer program product comprising at least one non-transitory computer-readable medium having computer-readable program code portions embodied therein, the computer-readable program code portions comprising:
an executable portion configured for generating and presenting engagement reporting tool to a user such that the engagement reporting tool is stored locally with the user;
an executable portion configured for retrieving information about one or more incidents within an entity, wherein the retrieved information about the one or more incidents is based at least in part on the user selecting a range of information to retrieve;
an executable portion configured for ranking priority and impact of the one or more incidents, wherein high priority incidents are identified;
an executable portion configured for populating a triage engagement report with triage information for each of the high priority incidents identified;
an executable portion configured for determining triage support audience associated with the triage engagement report; and
an executable portion configured for presenting the triage engagement report to the triage support audience.

9. The computer program product of claim 8 further comprising an executable portion configured for extracting high priority incidents for triage support from the retrieved information about one or more incidents.

10. The computer program product of claim 8, wherein high priority incidents are incidents within a group at the entity that are associated with financial aspects of the group including payments.

11. The computer program product of claim 8, wherein ranking the priority and the impact of the one or more incidents includes applying logic to each of the incidents to determine the highest priority, wherein the logic includes learning from historical incident rankings, comparing a type of incident across the one or more incidents, and comparing groups where the one or more incidents originated.

12. The computer program product of claim 8, wherein retrieving information about one or more incidents within an entity further comprises the user selecting a date range, priority of incident, type of incident, or field of incident for the retrieving.

13. The computer program product of claim 8, wherein triage information populated on the triage engagement report includes generating a ticket number, generating an application code, generating a weight and impact, presenting communication summaries, and notes for each of the high priority incidents identified.

14. The computer program product of claim 8, wherein triage information populated on the triage engagement report include a generating a ticket number linked to the data about the high priority incident not on the engagement report.

15. A computer-implemented method for triage engagement reporting, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
generating and presenting engagement reporting tool to a user such that the engagement reporting tool is stored locally with the user;
retrieving information about one or more incidents within an entity, wherein the retrieved information about the one or more incidents is based at least in part on the user selecting a range of information to retrieve;
ranking, via a computer device processor, priority and impact of the one or more incidents, wherein high priority incidents are identified;
populating a triage engagement report with triage information for each of the high priority incidents identified;
determining triage support audience associated with the triage engagement report; and
presenting the triage engagement report to the triage support audience.

16. The computer-implemented method of claim 15 further comprising extracting high priority incidents for triage support from the retrieved information about one or more incidents.

17. The computer-implemented method of claim 15, wherein high priority incidents are incidents within a group at the entity that are associated with financial aspects of the group including payments.

18. The computer-implemented method of claim 15, wherein ranking the priority and the impact of the one or more incidents includes applying logic to each of the incidents to determine the highest priority, wherein the logic includes learning from historical incident rankings, comparing a type of incident across the one or more incidents, and comparing groups where the one or more incidents originated.

19. The computer-implemented method of claim 15, wherein retrieving information about one or more incidents within an entity further comprises the user selecting a date range, priority of incident, type of incident, or field of incident for the retrieving.

20. The computer-implemented method of claim 15, wherein triage information populated on the triage engagement report includes generating a ticket number, generating an application code, generating a weight and impact, presenting communication summaries, and notes for each of the high priority incidents identified.

21. The computer-implemented method of claim 15, wherein triage information populated on the triage engagement report include a generating a ticket number linked to the data about the high priority incident not on the engagement report.
